(19) United States
(12) Patent Application Publication
(10) Pub. No.: US 2011/0176645 A1
(43) Pub. Date: Jul. 21, 2011

(54) METHOD AND APPARATUS FOR ESTIMATING NOISE AND INTERFERENCE POWER IN WIRELESS TELECOMMUNICATIONS SYSTEM

(75) Inventor: Hwa-Sun YOU, Suwon-si (KR)

(73) Assignee: SAMSUNG ELECTRONICS CO. LTD., Suwon-si (KR)

(21) Appl. No.: 12/979,638

(22) Filed: Dec. 28, 2010

(30) Foreign Application Priority Data
Jan. 20, 2010 (KR) 10-2010-0005210

(51) Int. Cl. H04B 1/10

(52) U.S. Cl. 375/346

(57) ABSTRACT

A method and apparatus for estimating a noise and interference power in a wireless communication system are provided. Once a receiver receives an uplink signal from a terminal through an uplink channel to which semi-orthogonal sequences can be mapped, an estimator estimates an average power of signal components of the uplink signal and an average power of noise and interference components of the uplink signal by using correlation characteristics of the semi-orthogonal sequences, and a converter converts the average power of the signal components and the average power of the noise and interference components into a Carrier-to-Noise and Interference Ratio (CNIR). In this way, by simply and accurately estimating a CINR using semi-orthogonality of an uplink channel, stable and flexible system management becomes possible.

### PRIORITY

This application claims the benefit under 35 U.S.C. §119(a) of a Korean patent application filed in the Korean Intellectual Property Office on Jan. 20, 2010 and assigned Serial No. 10-2010-0005210, the entire disclosure of which is hereby incorporated by reference.

### BACKGROUND OF THE INVENTION

1. Field of the Invention

The present invention relates to a wireless communication system. More particularly, the present invention relates to a method and apparatus for estimating noise power of semi-orthogonal sequences on a communication channel between a transmitter and a receiver.

2. Description of the Related Art

In a broadband wireless communication system supporting multimedia services, such as voice and data services, specifically defined orthogonal or semi-orthogonal sequences may be exchanged between a base station and a mobile station to transmit control information having various purposes. A receiving end uses the orthogonal or semi-orthogonal sequences to estimate information about signal and noise power, for example, a Carrier-to-Interference and Noise Ratio (CINR), used to determine combining coefficients or power control of multiple antennas.

In a communication system based on Orthogonal Frequency Division Multiple Access (OFDMA), separate physical channels for transmitting uplink fast feedback information are used. The uplink fast feedback information may be an absolute Signal-to-Noise Ratio (SNR), a Carrier to Interference Ratio (CIR), a differential SNR for each band, or a fast Multi Input Multi Output (MIMO) mode. In a fast mobile communication system, the base station schedules transmission of packet data and determines a transmission parameter by using such fast feedback information indicating downlink quality and state, thereby implementing a fast packet data service.

The mobile station transmits fast feedback information to the base station through a physical channel called a Fast Feedback Channel (FBCH), in which the fast feedback information is periodically reported in an uplink during communication of the mobile station. Thus, the FBCH may be useful for the base station to acquire state information of an uplink channel in a period where there is no uplink traffic signal allocated to the mobile station. In particular, the base station can perform power control on uplink channels by estimating a CINR for the FBCH. When power control for the uplink is not performed correctly, inter-cell interference increases, which leads to a degradation of link performance or a failure regarding maintenance of a stable communication state and thus a failure to satisfy a required Quality of Service (QoS). This leads to a reduction in a data rate, thus reducing cell throughput.

Since the FBCH generally has to maintain a low error level even in a poor channel environment, reliable noise and interference levels and a reliable CINR estimation method for the uplink FBCH are required for stable management.

Conventionally, signal component power and noise component power have been acquired by using additional information. However, since a separate pilot signal does not exist in the FBCH, CINR estimation is difficult to perform and antenna combining coefficients are especially difficult to acquire. Moreover, in a base station receiving environment including Remote Radio Heads (RRH) or a repeater, stable reception performance cannot be guaranteed.

Accordingly, there is a need for an improved method and apparatus for estimating an average power of noise/interference components by using semi-orthogonal sequences of an FBCH in a wireless communication system.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for estimating an average power of noise/interference components by using semi-orthogonal sequences of a Fast Feedback Channel (FBCH) in a wireless communication system.

Another aspect of the present invention is to provide a method and apparatus for efficiently estimating a signal power and a noise/interference power of a communication channel between a transmitter and a receiver by using an output of a non-coherent demodulator used for receiver sequence decision in a wireless communication system.

In addition, another aspect of the present invention is to provide a method and apparatus for efficiently estimating a Carrier-to-Interference and Noise Ratio (CINR) of a communication channel between a transmitter and a receiver by using semi-orthogonal sequences used for information requiring high reliability even in an environment having severe distortion such as severe noise, like in an FBCH of a mobile station.

According to an aspect of the present invention, a method for estimating a noise and interference power in a wireless communication system is provided. The method includes receiving an uplink signal from a mobile station through an uplink channel to which semi-orthogonal sequences can be mapped, estimating an average power for signal components of the uplink signal and an average power for noise and interference components of the uplink signal by using correlation characteristics of the semi-orthogonal sequences, and converting the average power for the signal components and the average power for the noise and interference components into a CNIR.

According to another aspect of the present invention, an apparatus for estimating a noise and interference power in a wireless communication system is provided. The apparatus includes a receiver for receiving an uplink signal from a mobile station through an uplink channel to which semi-orthogonal sequences can be mapped, an estimator for estimating an average power for signal components of the uplink signal and an average power for noise and interference components of the uplink signal by using correlation characteristics of the semi-orthogonal sequences, and a converter for converting the average power of the signal components and the average power of the noise and interference components into a CNIR.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram of a wireless communication system according to an exemplary embodiment of the present invention;

FIG. 2 is a block diagram of a mobile station transmitter for transmitting uplink fast feedback information according to an exemplary embodiment of the present invention;

FIG. 3 is a block diagram of a base station receiver for receiving uplink fast feedback information according to an exemplary embodiment of the present invention;

FIG. 4 is a block diagram of a Carrier-to-Interference and Noise Ratio (CINR) estimator including non-coherent demodulation according to an exemplary embodiment of the present invention;

FIG. 5 is a block diagram of a Primary-Fast Feedback Channel (P-FBCH) applicable to an exemplary embodiment of the present invention;

FIG. 6 is a block diagram of a CINR estimator including non-coherent demodulation according to an exemplary embodiment of the present invention; and

FIG. 7 is a flowchart illustrating a CINR calculation operation according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Herein, to describe exemplary noise and interference estimation operations in a wireless communication system, communication standards based on the Institute of Electrical and Electronics Engineers (IEEE) 802.16m standard will be referred to. However, application and operations of the present invention are not limited to a particular communication protocol or system structure, and it would be obvious to those of ordinary skill in the art that various modifications can be made without departing from the subject matter of the present invention. More specifically, exemplary embodiments of the present invention described below can be applied to a case where semi-orthogonal sequences are used to transmit control information having various purposes in a wireless communication system.

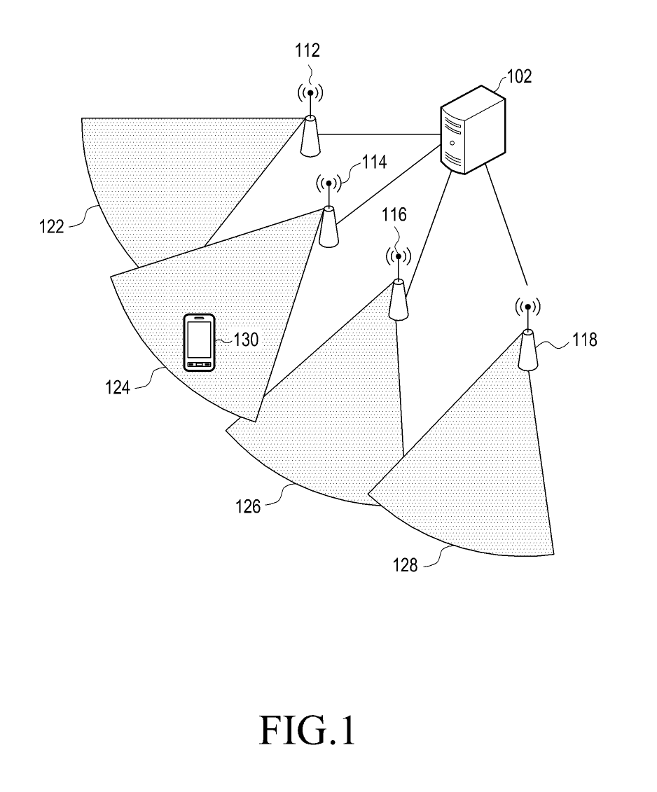

FIG. 1 is a schematic diagram of a wireless communication system according to an exemplary embodiment of the present invention.

Referring to FIG. 1, a base station 102 is structured to receive uplink signals from a mobile station 130 via several antennas 112, 114, 116, and 118. The mobile station 130 transmits uplink signals to the base station 102 while located in one of coverage areas 122, 124, 126, and 128 formed by the antennas 112 through 118 or while located in an overlap region between the coverage areas 122, 124, 126, and 128.

In a system structure where several antenna ports provided in the base station 102 are connected with the antennas 112 through 118 in the form of Remote Radio Heads (RRH) or one of the antenna ports provided in the base station 102 is connected to a repeater, a reception signal of the mobile station 130 located in the coverage area 124 is received with a high level via a particular antenna (for example, 114), whereas a level of the reception signal may be very low or only noise and interference may be received via the other antennas 112, 116, and 118.

In this case, the base station 102 may apply a low weight value to the antennas 112, 116, and 118 having low reception signal quality during an antenna combining operation or exclude the antennas 112, 116, and 118 from the antenna combining operation, thereby improving reception performance of a base station modem. To perform antenna-based power control, the calculation of antenna combining coefficients is essential. To this end, a Carrier-to-Interference and Noise Ratio (CINR) indicating a ratio of a signal level to a noise and interference level is required.

Since an uplink traffic signal is assigned a unique dedicated pilot for each mobile station, a base station may measure a noise and interference level for an uplink channel from the mobile station to the base station by using the dedicated pilot and variations in antenna port reception quality can be addressed by a whitening process performed before bit detection. On the other hand, a dedicated pilot does not exist in an FBCH, a receiver of which is structured with a non-coherent demodulator, that is, a non-coherent detector. As a result, a method for estimating a noise and interference level and a compensation method based on a whitening process, which are used in a traffic channel, cannot be applied to an FBCH.

However, since the FBCH generally has to maintain a low error level even in a poor channel environment, a reliable CINR estimation method for an uplink FBCH is required for stable management.

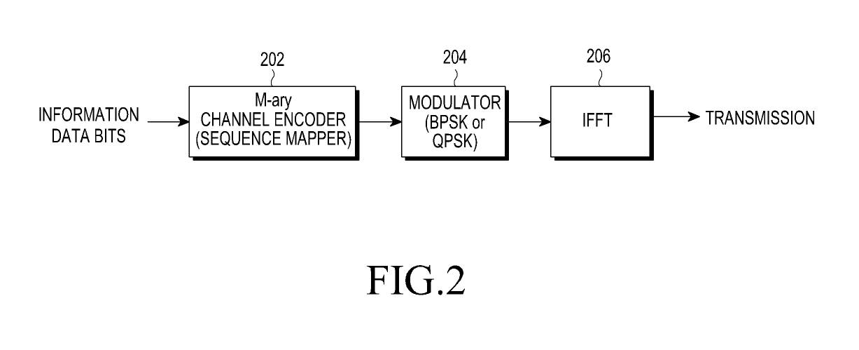

FIG. 2 is a block diagram of a mobile station transmitter for transmitting uplink fast feedback information according to an exemplary embodiment of the present invention.

Referring to FIG. 2, the mobile station transmitter includes an M-ary channel encoder 202, a modulator 204, and an Inverse Fast Fourier Transformer (IFFT) 206.

Data bits constituting uplink fast feedback information to be transmitted may have a length ‘l’ of 4 to 6 bits according to contents of the uplink fast feedback information, and are input to the M-ary channel encoder 202. An operation of the channel encoder 202 includes a process of selecting a sequence mapped to the input data bits from among M sequences (i.e., codewords) according to a mapping relationship agreed upon between a transmitter and a receiver, in which a relation M=2*l may be established according to a length of the uplink fast feedback information. Herein, semi-orthogonal sequences are used as the M sequences (that is, codewords), such that the M-ary channel encoder 202 may be called, for example, a sequence mapper. The modulator 204 receives the codewords output from the channel encoder 202 and performs Binary Phase Shift Keying (BPSK) or Quadrature PSK (QPSK) on the output codewords according to a predetermined transmission scheme, thus generates transmission symbols. The IFFT 206 receives the transmission symbols output from the modulator 204 and performs inverse fast Fourier transformation on the transmission symbols.

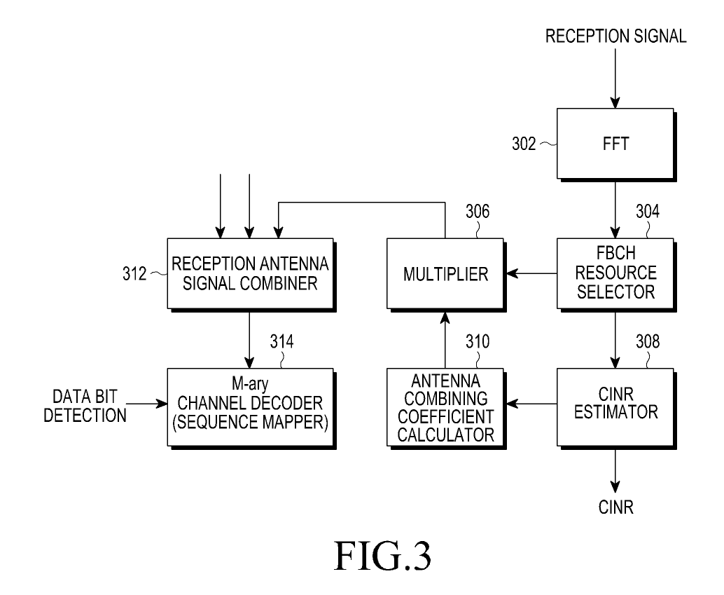

FIG. 3 is a block diagram of a base station receiver for receiving uplink fast feedback information according to an exemplary embodiment of the present invention.

Referring to FIG. 3, the base station receiver includes an FFT 302, an FBCH resource selector 304, a multiplier 306, a CINR estimator 308, an antenna combining coefficient calculator 310, and a reception antenna signal combiner 312, and an M-ary channel decoder 314.

A reception signal at each antenna is input to the FFT 302. The FFT 302 receives the reception signal and performs FFT on the reception signal to separate and extract a signal mapped to a time-frequency resource of an FBCH. The CINR estimator 308 estimates a noise and interference level for the extracted signal and converts the estimated noise and interference level into a CINR.

The noise and interference level or the CINR is input to the antenna combining coefficient calculator 310 to be converted into an antenna combining coefficient for a corresponding reception antenna. The multiplier 306 multiplies a reception signal of an FBCH for each reception antenna, which is output from the FBCH resource selector 304, by the corresponding antenna combining coefficient output from the antenna combining coefficient calculator 310, and the reception antenna signal combiner 312 combines signals multiplied by antenna combining coefficients corresponding to all reception antennas to output an antenna combined signal including signal-to-interference. The M-ary channel decoder 314 may detect data bits by decoding the antenna combined signal output from the reception antenna signal combiner 312.

If additional information such as a pilot exists in an FBCH, a signal component power and a noise component power required for CINR estimation are acquired by using the pilot. On the other hand, if there is no separate pilot signal in the FBCH, CINR estimation using the pilot cannot be performed.

As a scheme to improve the efficiency of CINR estimation, a method for estimating a signal component power and a noise component power by using correlation characteristics of sequences is proposed in an exemplary embodiment of the present invention, thereby improving the accuracy of uplink channel state estimation or flexibility of management.

Now, non-coherent demodulation in semi-orthogonal sequences will be described in brief.

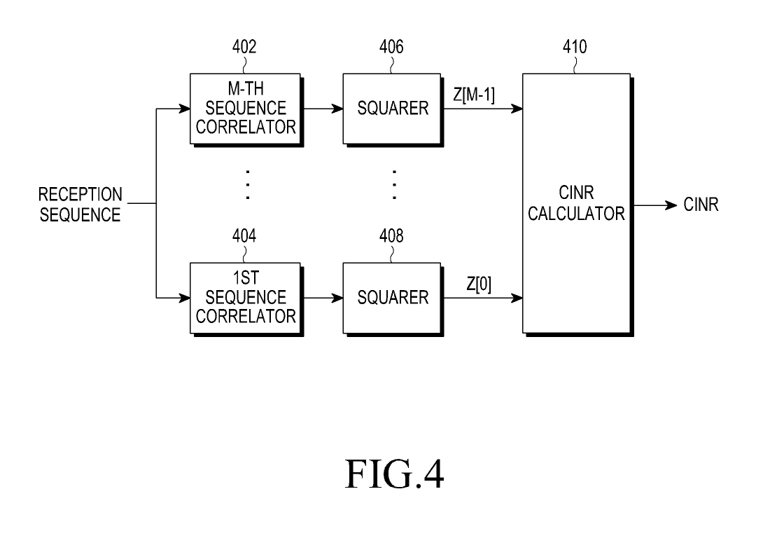

FIG. 4 is a block diagram of a CINR estimator including non-coherent demodulation according to an exemplary embodiment of the present invention.

Referring to FIG. 4, a channel signal used for CINR estimation, that is, a reception sequence of an FBCH is input to M sequence correlators 402 through 404. The M sequence correlators 402 through 404 respectively store all M sequences available in the FBCH and correlate the stored sequences with the reception sequence, thereby outputting correlation values. Squarers 406 through 408 calculate squares of the correlation values to remove phase components included in the correlation values output from the sequence correlators 402 through 404.

Outputs from the squarers 406 through 408 may be expressed by Equation (1):

$$Z [ i ] = {\vert {\sum }_{k = 1}^{L} {C}_{k}^{*} [ i ] \cdot {Y}_{k} \vert}^{2} , \\ i = 0 , … , M - 1 , \qquad ( 1 )$$

where Cₖ[i] represents a k-th signal component of a sequence having a sequence index i from among M codewords, that is, sequences, having a length of L. Yₖ represents a k-th signal component of a reception sequence, and Z[i] represents a non-coherent demodulation output for the sequence having the sequence index i.

A CINR calculator 410 uses a maximum value and an average value among M non-coherent demodulator outputs to estimate a CINR using Equation (2):

$$CINR = \frac{M \cdot max ( Z [ i ] ) - {\sum }_{i = 0}^{M - 1} Z [ i ]}{{\sum }_{i = 0}^{M - 1} Z [ i ] - ( 1 + ρ ) max ( Z [ i ] )} , \qquad ( 2 )$$

wherein ρ represents a sum of non-coherent demodulation outputs for different sequences and is defined by Equation (3):

$${ρ}_{l} = {\sum }_{l \neq m} {\vert {\sum }_{k = 1}^{L} {C}_{k} [ l ] \cdot {C}_{k}^{*} [ m ] \vert}^{2} , \qquad ( 3 )$$

wherein ρ₁ has a constant value regardless of a sequence index 1 by semi-orthogonality of sequences allocated to the FBCH, and thus may be simply expressed as ρ. That is, ρ is determined directly from used semi-orthogonal sequences irrespective of a reception environment.

To describe an exemplary embodiment of the present invention in more detail, characteristics of an uplink FBCH in an on Orthogonal Frequency Division Multiple Access (OFDMA) communication system will be described. Herein, a description will be made of an uplink FBCH used in an IEEE 802.16m system as an example.

The uplink FBCH used in the IEEE 802.16m system is classified into a Primary FBCH (P-FBCH) and a Secondary FBCH (S-FBCH), and for CINR estimation, the P-FBCH having a periodic feature is used.

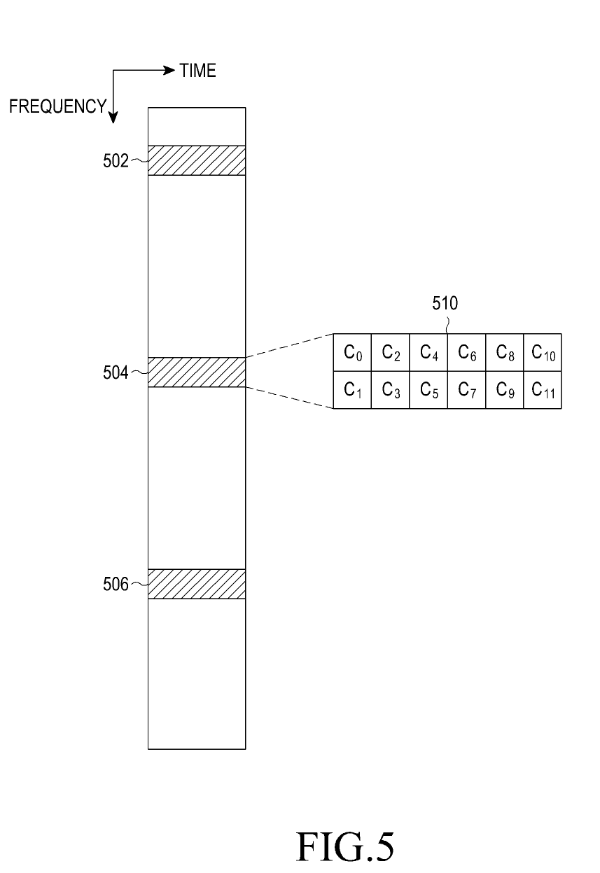

FIG. 5 is a block diagram of a P-FBCH applicable to an exemplary embodiment of the present invention.

Referring to FIG. 5, sequences 510 of the P-FBCH are allocated in the form of a plurality of subcarrier tiles on a frequency-time domain. Herein, each subcarrier tile is in a 2×6 form composed of 2 adjacent subcarriers and 6 OFDM symbols. Each subcarrier tile is allocated to different frequency positions, for example, three frequency positions 502, 504, and 506 as shown in FIG. 5, to acquire a frequency diversity gain.

As already described with reference to FIG. 2, information data to be transmitted through each subcarrier tile is converted into a single sequence while passing through the M-ary channel encoder 202. Sequences available in the P-FBCH have semi-orthogonality therebetween, for example, as shown in Table 1, and thus are called semi-orthogonal sequences.

TABLE 1

| Index | Sequence |
|---|---|
| 0 | 111111111111 |
| 1 | 101111010110 |
| 2 | 011010111101 |
| 3 | 001010010100 |
| 4 | 101010101010 |
| 5 | 111010000011 |
| 6 | 001111101000 |
| 7 | 011111000001 |
| 8 | 110011001100 |
| 9 | 100011100101 |
| 10 | 010110001110 |
| 11 | 000110100111 |
| 12 | 100110011001 |
| 13 | 110110110000 |
| 14 | 000011011011 |
| 15 | 010011110010 |
| 16 | 101011111100 |
| 17 | 111011010101 |
| 18 | 001110111110 |
| 19 | 011110010111 |
| 20 | 111110101001 |
| 21 | 101110000000 |
| 22 | 011011101011 |
| 23 | 001011000010 |
| 24 | 100111001111 |
| 25 | 110111100110 |
| 26 | 000010001101 |
| 27 | 010010100100 |
| 28 | 110010011010 |
| 29 | 100010110011 |
| 30 | 010111011000 |
| 31 | 000111110001 |
| 32 | 101011001001 |
| 33 | 111011100000 |
| 34 | 001110001011 |
| 35 | 011110100010 |
| 36 | 100111111010 |
| 37 | 110111010011 |
| 38 | 000010111000 |
| 39 | 010010010001 |
| 40 | 111110011100 |
| 41 | 101110110101 |
| 42 | 011011011110 |
| 43 | 001011110111 |
| 44 | 101010011111 |
| 45 | 111010110110 |
| 46 | 001111011101 |
| 47 | 011111110100 |
| 48 | 111111001010 |
| 49 | 101111100011 |
| 50 | 011010001000 |
| 51 | 001010100001 |
| 52 | 110010101111 |
| 53 | 100010000110 |
| 54 | 010111101101 |
| 55 | 000111000100 |
| 56 | 100110101100 |
| 57 | 110110000101 |
| 58 | 000011101110 |
| 59 | 010011000111 |
| 60 | 110011111001 |
| 61 | 100011010000 |
| 62 | 010110111011 |
| 63 | 000110010010 |

The M-ary channel encoder 202 determines a sequence index corresponding to information data and selects a sequence having a corresponding length of 12 by using mapping between sequence indices and sequences shown in Table 1.

The selected sequence is modulated and transmitted through the subcarrier tiles at the positions 502, 504, and 506 as shown in FIG. 5. To adapt to a fast environment and improve a frequency diversity gain, subcarrier mapping orders in the respective subcarrier tiles at the positions 502, 504, and 506 may vary.

At a receiving end, the M-ary channel decoder 314 correlates the reception sequence of the FBCH with all sequences shown in Table 1 for dispreading, and determines that information data corresponding to a sequence having a maximum correlation value has been transmitted. Outputs of the correlators for the reception sequence may be expressed by Equation (4):

$${Z}_{r} [ i ] = {\sum }_{m = 1}^{n \_ tile} {\vert {\sum }_{k = 1}^{n \_ tone} {C}_{m , k}^{*} [ i ] \cdot {Y}_{m , k} \vert}^{2} , \\ {C}_{m , k}^{*} [ i ] \cdot {Y}_{m , k} = {H}_{m , k} + {C}_{m , k}^{*} [ i ] \cdot {N}_{m , k} , \qquad ( 4 )$$

wherein Zᵣ[i] represents an output of a sum of a correlation value and a square of an i^{th} sequence for a reception signal received through an r^{th} antenna. Y_{m,k} represents a signal component received through a k-th subcarrier of an m-th subcarrier tile, m is an integer between 1 and n_tile, and k is an integer between 1 and n_tone. Herein, n_tile is the number of tiles for repetitively transmitting the same sequence, and n_tone is the number of tones forming each subcarrier tile and is equal to a length of a sequence. The tile denotes a unit of resource allocation, which is composed of a predetermined number of subcarriers and a predetermined number of symbols. C_{m,k}*[i] represents a k-th signal component of a sequence having a sequence index I for correlation with Y_{m,k}, and N_{m,k} and H_{m,k} represent an additional noise and a channel coefficient corresponding to Y_{m,k}, respectively.

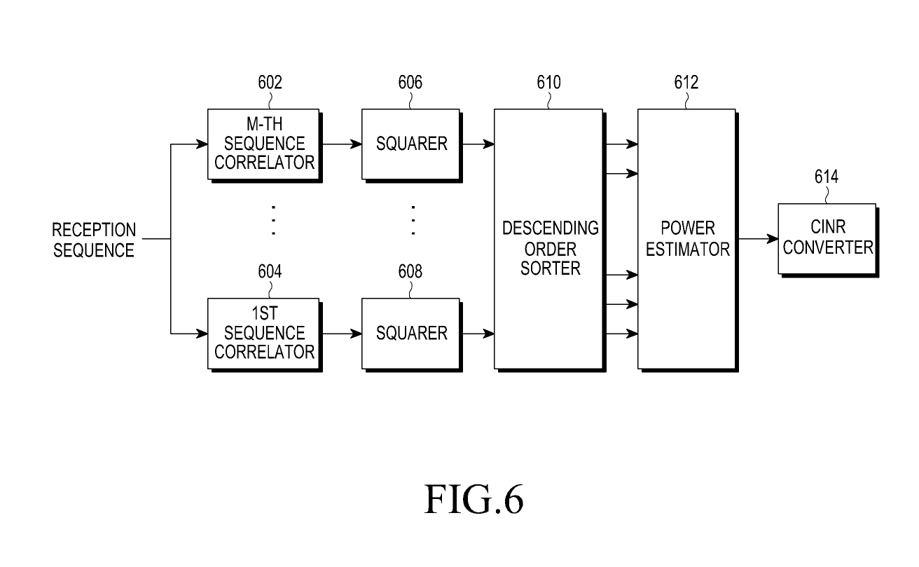

FIG. 6 is a block diagram of a CINR estimator including non-coherent demodulation according to an exemplary embodiment of the present invention.

Referring to FIG. 6, a channel signal used for CINR estimation, that is, a reception sequence of an FBCH is input to M sequence correlators 602 through 604. The sequence correlators 602 through 604 respectively store all M sequences available in the FBCH and correlate the stored sequences with the reception sequence to output correlation values. Squarers 606 through 608 calculate squares of the correlation values to remove phase components included in the correlation values output from the sequence correlators 602 through 604.

A descending order sorter 610 obtains a maximum value Zₘₐₓ and an average value Z_{avg} for the squares of the correlation values and delivers them to a power estimator 612. The power estimator 612 calculates an average power per tone for signal components and an average power per tone for noise and interference components based on the maximum value Zₘₐₓ and the average value Z_{avg}.

A CINR converter 614 calculates a CINR per antenna by using the estimated average power of the signal components and the estimated average power of the noise and interference components. The antenna combining coefficient calculator 310 then may calculate an antenna combining coefficient for improving the reception performance of a base station connected to include Remote Radio Heads (RRH) or a repeater, by using a CINR for each antenna calculated by the CINR converter 614 or the inverse of the average power of the noise and interference components estimated by the power estimator 612. In addition, a CINR calculated by a decision stage of the P-FBCH after antenna combination may also be used as a reference value for power control of a mobile station.

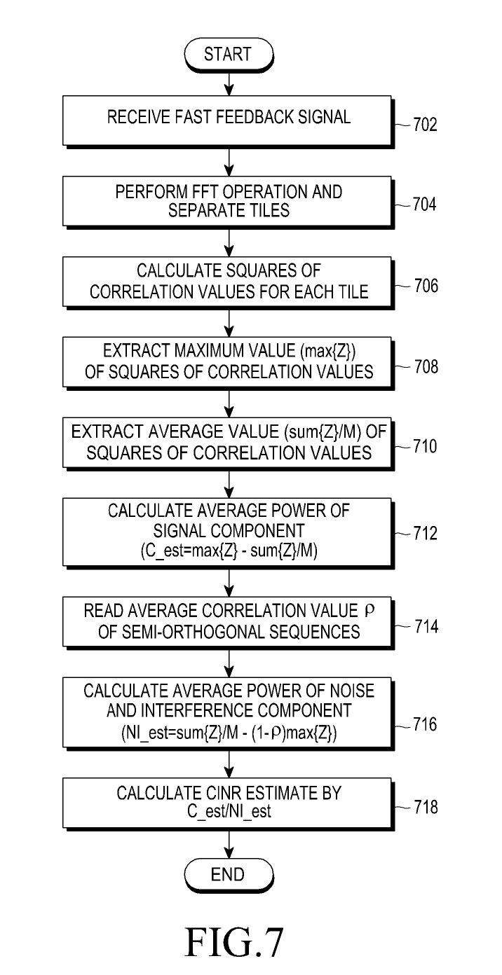

FIG. 7 is a flowchart illustrating a CINR calculation operation according to an exemplary embodiment of the present invention.

Referring to FIG. 7, upon reception of a signal including an FBCH in step 702, a receiver performs an FFT operation on the received signal and separates signals mapped to tiles allocated to the FBCH, i.e., fast feedback signals in step 704. In step 706, the receiver calculates squares of correlation values for a signal mapped to each tile. That is, the receiver correlates the signal mapped to each tile with all sequences that can be transmitted through the FBCH, to calculate the squares of the correlation values.

In step 708, the receiver extracts a maximum value max{Z} among the squares of the correlation values. In step 710, the receiver extracts an average value sum{Z}/M of the squares of the correlation values. In step 712, the receiver calculates an average power C_est for signal components of the fast feedback signal, using Equation (5).

C_{—}est=max{Z}−sum{Z}/M (5)

In step 714, the receiver reads an average correlation value ρ between semi-orthogonal sequences allocated to the FBCH from a memory. As previously stated, ρ is determined directly from used semi-orthogonal sequences, irrespective of a reception environment, and thus may be previously calculated and stored in the memory. In step 716, an average power NI_est of noise and interference components is calculated using Equation (6).

NI_{—}est=sum{Z}/M−(1−ρ) max{Z} (6)

In step 718, a CINR estimate is calculated from the average power of the signal components and the average power of the noise and interference components, using Equation (7).

CINR=C_{—}est/NI_{—}est (7)

A description will now be made of exemplary embodiments for CINR estimation using correlation characteristics shown in Table 1.

Referring to Table 1, a particular sequence, for example, a sequence “111111111111” having a sequence index 0 has 51 semi-orthogonal sequences and 12 orthogonal sequences. Thus, when the sequence “111111111111” is transmitted, a correlator outputs the largest correlation value (that is, a maximum value) for the same sequence, correlators for the semi-orthogonal sequences output the next largest correlation values, and correlators for the orthogonal sequences output the smallest correlation values. By using such correlation characteristics, a maximum value and an average value of squares of correlation values can be used to calculate an average power per tone of signal components and an average power per tone of noise and interference components.

In an exemplary embodiment, when sequences shown in Table 1 are used for an FBCH, an average power per tone of signal components can be calculated using Equation (8).

$${σ}_{H}^{2} = \frac{1}{132} ( {Z}_{max} - {Z}_{avg} ) \qquad ( 8 )$$

An average power per tone of noise and interference components can be calculated using Equation (9).

$${σ}_{N}^{2} = \frac{1}{132} ( 12 {Z}_{avg} - {Z}_{max} ) \qquad ( 9 )$$

The foregoing equations have been acquired by the above-described semi-orthogonal correlation characteristics of the sequences shown in Table 1.

According to another exemplary embodiment of the present invention, the descending order sorter 610 calculates a first maximum peak value Zₘₐₓ₁, which is the largest value among the squares of the correlation values, and a second maximum peak value Zₘₐₓ₂ which is the next largest value, and provides them to the power estimator 612. The power estimator 612 then calculates an average power per tone of signal components and an average power per tone of noise and interference components by using Equations (10) and (11).

$$\begin{matrix}{σ}_{H}^{2} = \frac{1}{128} ( {Z}_{max 1} - {Z}_{max 2} ) & ( 10 ) \\ {σ}_{N}^{2} = \frac{1}{96} ( 9 {Z}_{max 2} - {Z}_{max 1} ) & ( 11 )\end{matrix}$$

Likewise, the foregoing equations have been acquired by the above-described semi-orthogonal correlation characteristics of the sequences shown in Table 1.

Although not described in detail, various exemplary embodiments for CINR estimation using squares of correlation values through the descending order sorter 610 can be made with correlation characteristics of sequences. In other words, an equation for a CINR can be implemented variously according to the purpose of estimation and required accuracy and/or system complexity.

As can be appreciated from the foregoing description, according to exemplary embodiments of the present invention, by using intermediate and final outputs of a non-coherent demodulator for semi-orthogonal sequences used for modulation of an uplink FBCH, a CINR is accurately estimated, thus allowing accurate channel information transmission and stable system management. Moreover, exemplary embodiments of the present invention can be applied to any sub-channel structure regardless of a subcarrier tile form or a CINR management scheme, thereby allowing flexible system management.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for estimating a noise and interference power in a wireless communication system, the method comprising:
receiving an uplink signal from a mobile station through an uplink channel to which semi-orthogonal sequences can be mapped;
estimating an average power of signal components of the uplink signal and an average power of noise and interference components of the uplink signal by using correlation characteristics of the semi-orthogonal sequences; and
converting the average power of the signal components and the average power of the noise and interference components into a Carrier-to-Noise and Interference Ratio (CNIR).

2. The method of claim 1, wherein the estimating comprises:
calculating correlation values by correlating the uplink signal with the semi-orthogonal sequences that can be mapped to the uplink channel;
sorting squares of the correlation values to acquire a maximum value and an average value among the squares of the correlation values; and
calculating the average power of the signal components and the average power of the noise and interference components by using the maximum value and the average value.

3. The method of claim 1, wherein the average power of the signal components and the average power of the noise and interference components are calculated by the following equations:
$${σ}_{H}^{2} = \frac{1}{132} ( {Z}_{max} - {Z}_{avg} )$$
$$and$$
$${σ}_{N}^{2} = \frac{1}{132} ( 12 {Z}_{avg} - {Z}_{max} ) ,$$
where σ_{H}² represents the average power of the signal components, σ_{N}² represents the average power of the noise and interference components, Zₘₐₓ represents a maximum value among squares of correlation values, and Z_{avg} represents an average of the squares of the correlation values.

4. The method of claim 1, wherein the estimating comprises:
calculating correlation values by correlating the uplink signal with the semi-orthogonal sequences that can be mapped to the uplink channel;
sorting squares of the correlation values to acquire a first maximum value and a second maximum value among the squares of the correlation values; and
calculating the average power of the signal components and the average power of the noise and interference components by using the first maximum value and the second maximum value.

5. The method of claim 1, wherein the average power of the signal components and the average power of the noise and interference components are calculated by the following equations:
$${σ}_{H}^{2} = \frac{1}{128} ( {Z}_{max 1} - {Z}_{max 2} )$$
$$and$$
$${σ}_{N}^{2} = \frac{1}{96} ( 9 {Z}_{max 2} - {Z}_{max 1} ) ,$$
wherein σ_{H}² represents an average power of the signal components, σ_{N}² represents the average power of the noise and interference components, Zₘₐₓ₁ represents a first maximum value among squares of correlation values, and Zₘₐₓ₂ represents a second maximum value among the squares of the correlation values.

6. The method of claim 1, wherein the semi-orthogonal sequences are structured as the following table:

| Index | Sequence |
|---|---|
| 0 | 111111111111 |
| 1 | 101111010110 |
| 2 | 011010111101 |
| 3 | 001010010100 |
| 4 | 101010101010 |
| 5 | 111010000011 |
| 6 | 001111101000 |
| 7 | 011111000001 |
| 8 | 110011001100 |
| 9 | 100011100101 |
| 10 | 010110001110 |
| 11 | 000110100111 |
| 12 | 100110011001 |
| 13 | 110110110000 |
| 14 | 000011011011 |
| 15 | 010011110010 |
| 16 | 101011111100 |
| 17 | 111011010101 |
| 18 | 001110111110 |
| 19 | 011110010111 |
| 20 | 111110101001 |
| 21 | 101110000000 |
| 22 | 011011101011 |
| 23 | 001011000010 |
| 24 | 100111001111 |
| 25 | 110111100110 |
| 26 | 000010001101 |
| 27 | 010010100100 |
| 28 | 110010011010 |
| 29 | 100010110011 |
| 30 | 010111011000 |
| 31 | 000111110001 |
| 32 | 101011001001 |
| 33 | 111011100000 |
| 34 | 001110001011 |
| 35 | 011110100010 |
| 36 | 100111111010 |
| 37 | 110111010011 |
| 38 | 000010111000 |
| 39 | 010010010001 |
| 40 | 111110011100 |
| 41 | 101110110101 |
| 42 | 011011011110 |
| 43 | 001011110111 |
| 44 | 101010011111 |
| 45 | 111010110110 |
| 46 | 001111011101 |
| 47 | 011111110100 |
| 48 | 111111001010 |
| 49 | 101111100011 |
| 50 | 011010001000 |
| 51 | 001010100001 |
| 52 | 110010101111 |
| 53 | 100010000110 |
| 54 | 010111101101 |
| 55 | 000111000100 |
| 56 | 100110101100 |
| 57 | 110110000101 |
| 58 | 000011101110 |
| 59 | 010011000111 |
| 60 | 110011111001 |
| 61 | 100011010000 |
| 62 | 010110111011 |
| 63 | 000110010010 |

7. An apparatus for estimating a noise and interference power in a wireless communication system, the apparatus comprising:
a receiver for receiving an uplink signal from a terminal through an uplink channel to which semi-orthogonal sequences can be mapped;
an estimator for estimating an average power of signal components of the uplink signal and an average power of noise and interference components of the uplink signal by using correlation characteristics of the semi-orthogonal sequences; and
a converter for converting the average power of the signal components and the average power of the noise and interference components into a Carrier-to-Noise and Interference Ratio (CNIR).

8. The apparatus of claim 7, wherein the estimator comprises:
correlators for calculating correlation values by correlating the uplink signal with the semi-orthogonal sequences that can be mapped to the uplink channel;
squarers for calculating squares of the correlation values;
a descending order sorter for sorting the squares to acquire a maximum value and an average value among the squares of the correlation values; and
a power estimator for calculating the average power of the signal components and the average power of the noise and interference components by using the maximum value and the average value.

9. The apparatus of claim 7, wherein the average power of the signal components and the average power of the noise and interference components are calculated by the following equations:
$${σ}_{H}^{2} = \frac{1}{132} ( {Z}_{max} - {Z}_{avg} )$$
$$and$$
$${σ}_{N}^{2} = \frac{1}{132} ( 12 {Z}_{avg} - {Z}_{max} ) ,$$
where σ_{H}² represents the average power of the signal components, σ_{N}² represents the average power of the noise and interference components, Zₘₐₓ represents a maximum value among squares of correlation values, and Z_{avg} represents an average of the squares of the correlation values.

10. The apparatus of claim 7, wherein the estimator comprises:
correlators for calculating correlation values by correlating the uplink signal with the semi-orthogonal sequences that can be mapped to the uplink channel;
squarers for calculating squares of the correlation values;
a descending order sorter for sorting squares of the correlation values to acquire a first maximum value and a second maximum value among the squares of the correlation values; and
a power estimator for calculating the average power of the signal components and the average power of the noise and interference components by using the first maximum value and the second maximum value.

11. The apparatus of claim 7, wherein the average power of the signal components and the average power of the noise and interference components are calculated by the following equations:
$${σ}_{H}^{2} = \frac{1}{128} ( {Z}_{max 1} - {Z}_{max 2} )$$
$$and$$
$${σ}_{N}^{2} = \frac{1}{96} ( 9 {Z}_{max 2} - {Z}_{max 1} ) ,$$
wherein σ_{H}² represents an average power of the signal components, σ_{N}² represents the average power of the noise and interference components, Zₘₐₓ₁ represents a first maximum value among squares of correlation values, and Zₘₐₓ₂ represents a second maximum value among the squares of the correlation values.

12. The apparatus of claim 7, wherein the semi-orthogonal sequences are structured as the following table:

| Index | Sequence |
|---|---|
| 0 | 111111111111 |
| 1 | 101111010110 |
| 2 | 011010111101 |
| 3 | 001010010100 |
| 4 | 101010101010 |
| 5 | 111010000011 |
| 6 | 001111101000 |
| 7 | 011111000001 |
| 8 | 110011001100 |
| 9 | 100011100101 |
| 10 | 010110001110 |
| 11 | 000110100111 |
| 12 | 100110011001 |
| 13 | 110110110000 |
| 14 | 000011011011 |
| 15 | 010011110010 |
| 16 | 101011111100 |
| 17 | 111011010101 |
| 18 | 001110111110 |
| 19 | 011110010111 |
| 20 | 111110101001 |
| 21 | 101110000000 |
| 22 | 011011101011 |
| 23 | 001011000010 |
| 24 | 100111001111 |
| 25 | 110111100110 |
| 26 | 000010001101 |
| 27 | 010010100100 |
| 28 | 110010011010 |
| 29 | 100010110011 |
| 30 | 010111011000 |
| 31 | 000111110001 |
| 32 | 101011001001 |
| 33 | 111011100000 |
| 34 | 001110001011 |
| 35 | 011110100010 |
| 36 | 100111111010 |
| 37 | 110111010011 |
| 38 | 000010111000 |
| 39 | 010010010001 |
| 40 | 111110011100 |
| 41 | 101110110101 |
| 42 | 011011011110 |
| 43 | 001011110111 |
| 44 | 101010011111 |
| 45 | 111010110110 |
| 46 | 001111011101 |
| 47 | 011111110100 |
| 48 | 111111001010 |
| 49 | 101111100011 |
| 50 | 011010001000 |
| 51 | 001010100001 |
| 52 | 110010101111 |
| 53 | 100010000110 |
| 54 | 010111101101 |
| 55 | 000111000100 |
| 56 | 100110101100 |
| 57 | 110110000101 |
| 58 | 000011101110 |
| 59 | 010011000111 |
| 60 | 110011111001 |
| 61 | 100011010000 |
| 62 | 010110111011 |
| 63 | 000110010010 |
